(19) United States
(12) Patent Application Publication
(10) Pub. No.: US 2008/0046567 A1
(43) Pub. Date: Feb. 21, 2008

(54) Automatic detection and integration of network workloads

(75) Inventors: Eric B. Watson, Redmond, WA (US); Lingan Satkunanathan, Kirkland, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/507,088

(22) Filed: Aug. 18, 2006

(51) Int. Cl. G06F 15/173

(52) U.S. Cl. 709/226; 709/223

(57) ABSTRACT

Described is a computer networking-related technology by which a network workload that is not integrated into a network is detected and integrated into the network. The workload may comprise a device, a service or a product. The detection and integration may be automatic, at least in part. Upon detection, configuration information (such as contained in a plug-in component) that is associated with the workload is located, and used to configure the workload to operate in the network. A network program (e.g., of a suite of network-related programs) is also configured as necessary to work with the workload. The plug-in may be located in on-premise storage or in a remote location.

### BACKGROUND

In a computer network, e.g., an information technology (IT) infrastructure, a large source of dissatisfaction among network administrators is caused by difficulties in getting the products of different vendors to work together. This is one reason that enterprises often prefer to buy integrated software suites.

However, when dealing with the concept of workloads that perform specific functions, (with each workload corresponding to a network device such as a hardware firewall device, a network attached storage/NAS appliance, an edge device, or a service such as email, a print service, a file service, a directory service and so forth) there is currently no integration across workloads or within workloads from different vendor (e.g., network firewalls from different vendors). It would be highly difficult for a single vendor to build, integrate, configure and also centrally manage a “suite” of workloads needed for various enterprises' computing infrastructures.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a workload that is not integrated into a network is integrated into the network by locating configuration information associated with the workload, and using the configuration information to configure the workload to operate in the network, and configuring a network program to work with the workload. The workload may comprise a device, a service or a product. The configuration information may be maintained in a data structure referred to as a plug-in. The network program may be part of network suite software including a mechanism that locates the configuration information and/or processes the configuration information to integrate the workload. This processing may be based on logic embedded in the program or elsewhere.

Upon detection of a network workload that is associated with the network but not integrated into the network, the mechanism may search an on-premise data store to look for a data structure (e.g., plug-in) containing the configuration information for the workload. The mechanism may instead, or additionally, search one or more remote (e.g., Internet) locations for a data structure containing the configuration information for the workload. When found, integration may be automatic or may involve administrator input.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 shows an illustrative example of a general-purpose network computing environment into which various aspects of the present invention may be incorporated.

FIG. 2 is a block diagram representing example workloads coupled to a network software program suite that uses plug-ins to configure detected workloads to work in the network.

FIG. 3 is a flow diagram showing example actions that may be taken upon detecting a workload to configure the workload and network software to work with one another.

FIG. 4 shows an illustrative example of a general-purpose computing environment including a computer into which various aspects of the present invention may be incorporated.

### DETAILED DESCRIPTION

Various aspects of the technology described herein are generally directed towards detecting workloads (devices, services, products and so forth) in a network environment that had not previously been configured to work with the network. This may be because the workload was just added to the network, or because it was detected sometime after it was added, but was not previously detectable by the appropriate software (or the software was not yet installed). Upon detection, the workload may be configured to work with network software, and the network software may be configured to work with the workload, thereby integrating the workload into the network.

In one example implementation, the workload detection and configuration mechanism is incorporated into a suite of network-related software programs typically used in an information technology (IT) infrastructure, and referred to herein as network software suite. Examples of programs that may be present within such a suite include an administration console, an email server program, an antivirus and/or spam filtering program, a file server program, and so forth. Other on-premise workloads may be external to the suite. Notwithstanding, it can be readily appreciated that instead of a suite, a standalone program or other entity (e.g., a dedicated device) may include the workload detection and configuration mechanism, or the mechanism may be part of another program such as an application program or operating system component, and so forth. Indeed, some or all of the components of the workload detection and configuration mechanism may not necessarily be literally on-premise and/or in one location, but rather can in whole or in part be accessed remotely, such as via a workload detection and configuration mechanism service that is used by an on-premise computer program, for example.

As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and network management in general.

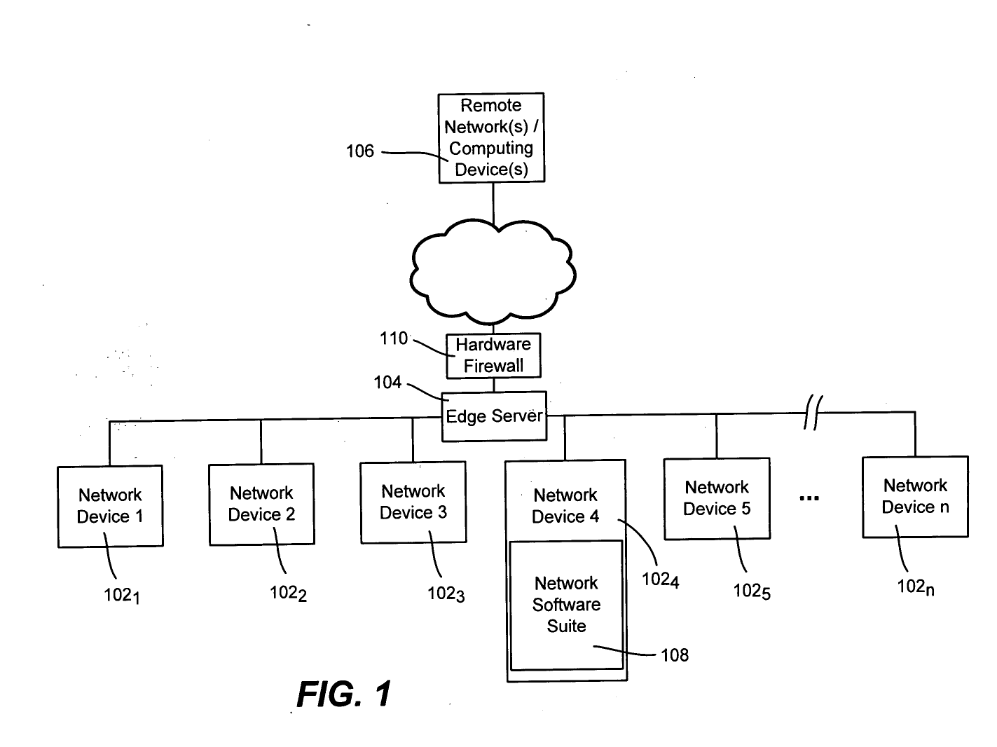

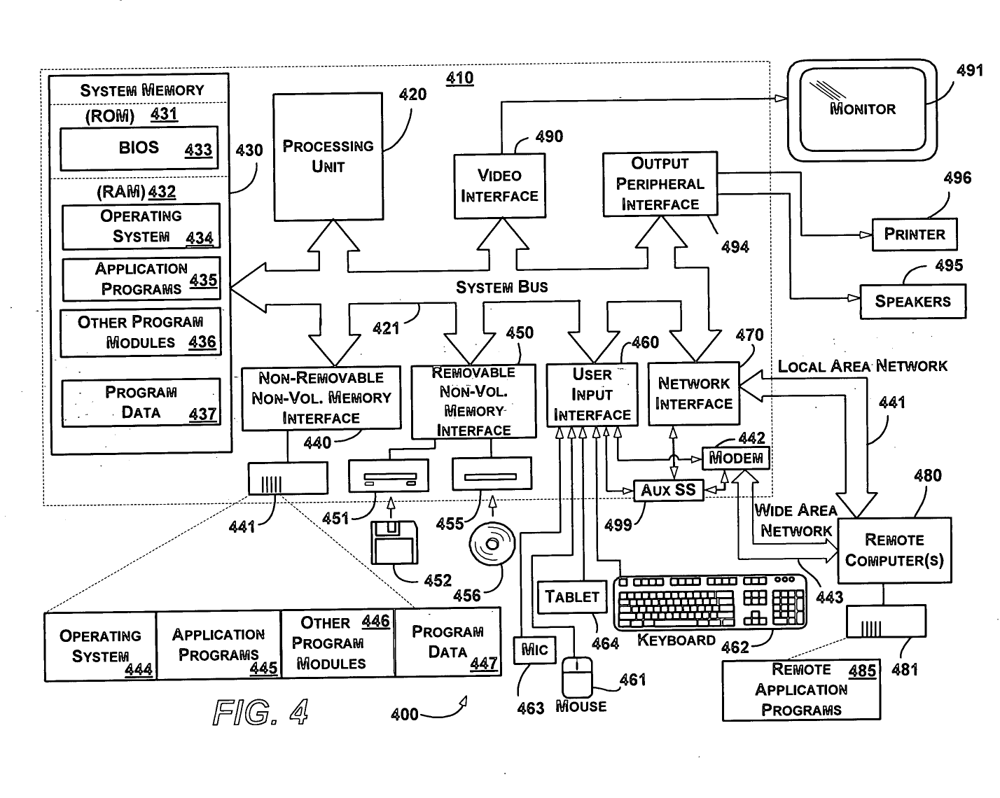

FIG. 1 shows an example network arrangement for a hypothetical enterprise, in which a number of computing devices 102₁-102ₙ are coupled via an edge server 104 to other remote networks and/or computing devices 106. The computing devices 102₁-102ₙ may be any device capable of running code and/or containing logic. Note that while an edge server 104 is shown within this example of FIG. 1, the technology described herein may apply to many other products and configurations, including one in which an edge server may not be present; indeed, as set forth above, at least some of the technology described herein may apply to a standalone machine (e.g., the computer 410 of FIG. 4), or a peer-to-peer network or a client server network. Further, although not shown in FIG. 1, it is understood that various other networking components may be present, e.g., routers, switches, hubs, modems, and other hardware-based firewalls.

One of the computing devices (e.g., 102₄) is shown as maintaining the on-premise network software suite 108, which as described above need not be entirely “on-premise” in a literal sense. Further, it is understood that even in a configuration in which the network software suite 108 is literally “on-premise” within a network, the network software suite 108 may be distributed among more than one network device. Thus, for example, the network software suite may comprise one or more programs that run at least in part on the edge server 104; further although not shown as such in the example of FIG. 1, the network software suite 108 may be a program that runs entirely on the edge server 104.

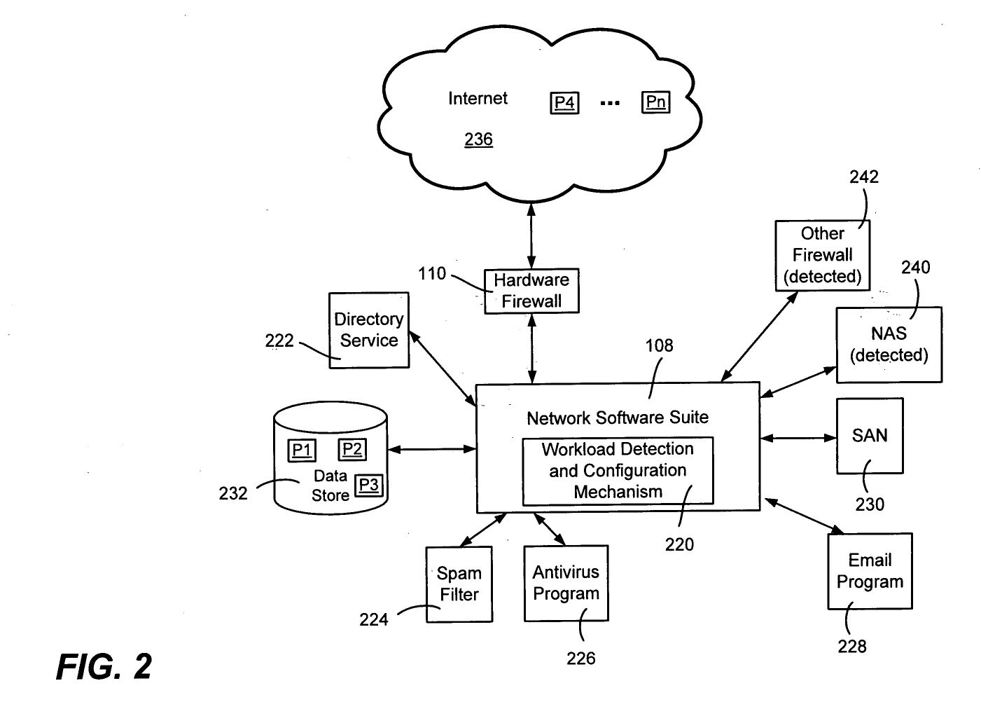

In one example implementation represented in FIG. 2, the network software suite 108 includes or is otherwise associated with a workload detection and configuration mechanism 220. Workloads shown in FIG. 2 include a directory service 222, the hardware firewall (of FIG. 1), a spam filter 224, an antivirus program 226, an email program 228, and a SAN (storage area network) 230.

In general, the workload detection and configuration mechanism 220 enables a suite of network server software programs to not only be integrated with its own workloads, but also to integrate with external workloads comprising devices, products and services. To this end, the workload detection and configuration mechanism 220 detects such external workloads (e.g., the NAS device 240 and the other firewall 242), and provides integrated configuration of to fully integrate into the suite's own environment.

Detection of a device attached on the network (e.g., rather than locally) may take place in a number of ways, which may depend on the type of workload that is detected. For example, in an Active Directory® environment or with a similar directory service, queries may be made to determine what workloads (e.g., applications) are registered. Configuration data stores of local environments may also be queried. Probes can also be performed, such to use IP addresses to determine how the network is being traversed, e.g., to locate firewalls and the like. Device detection and integration may happen at the time that the suite is installed, or anytime thereafter, and need not be triggered by the immediate act of attaching the workload or workload installation.

To configure a workload once the workload is detected and recognized, the workload detection and configuration mechanism 220 attempts to locate configuration information for the detected workload, which in one example implementation is contained in a plug-in (e.g., a file or other data structure, such as containing configuration settings, instructions in executable code/script, and so forth). As represented in FIG. 2, plug-ins (e.g., P1-P3) may be maintained in an on-premise data store 232, while others (e.g., P4-Pn) may be maintained remotely, e.g., accessed via the internet 236.

In general, a plug-in comprises an updatable translation layer that provides information needed to translate between the software suite's actions and the workload's methods for configuration and integration. The configuration information may be available through industry standards or because the plug-in translates to a proprietary method. For example, one manufacturer's firewall may require different configuration steps and settings from those required by another manufacturer's firewall. Each may have a plug-in that executes the steps to configure the workload with the settings, possibly obtaining administrator preferences for variable settings via a user interface of the plug-in or a user interface of the suite to which the plug-ins interface. Note that the integration may be for configuring the workload as part of deployment, or integration may be during deployment and for continued use. The configuration may be entirely automated, but may be partially (or completely) manual.

By way of example, consider that the workload detection and configuration mechanism 220 detects the NAS device 240 on the network, and already has an appropriate plug-in (e.g., P3) for that device. The workload detection and configuration mechanism 220 may prompt the administrator to determine whether to configure the NAS for use with the suite 108, or configuration may be set to automatically occur. If the device is to be integrated, the workload detection and configuration mechanism 220 will access the plug-in's configuration information to configure the NAS device 240 as needed, and configure the suite software 108 to use the NAS device 240, e.g., to move at least some of the suite's data storage from being mapped to local drives to being mapped to the NAS device 240.

As another example, consider that the workload detection and configuration mechanism 220 discovers a firewall device 242 having Universal Plug-and-Play (UP&P) support. The workload detection and configuration mechanism 220 automatically prompts the administrator to determine whether to route Internet traffic through the device 242, and if so, and a plug-in (e.g., P4) is located for that firewall device 242. Using the configuration information, the workload detection and configuration mechanism 220 configures the firewall device 242 to have the appropriate ports open for the suite software 108. The workload detection and configuration mechanism 220 also modifies the suite's networking configuration to route Internet traffic through the firewall device 242.

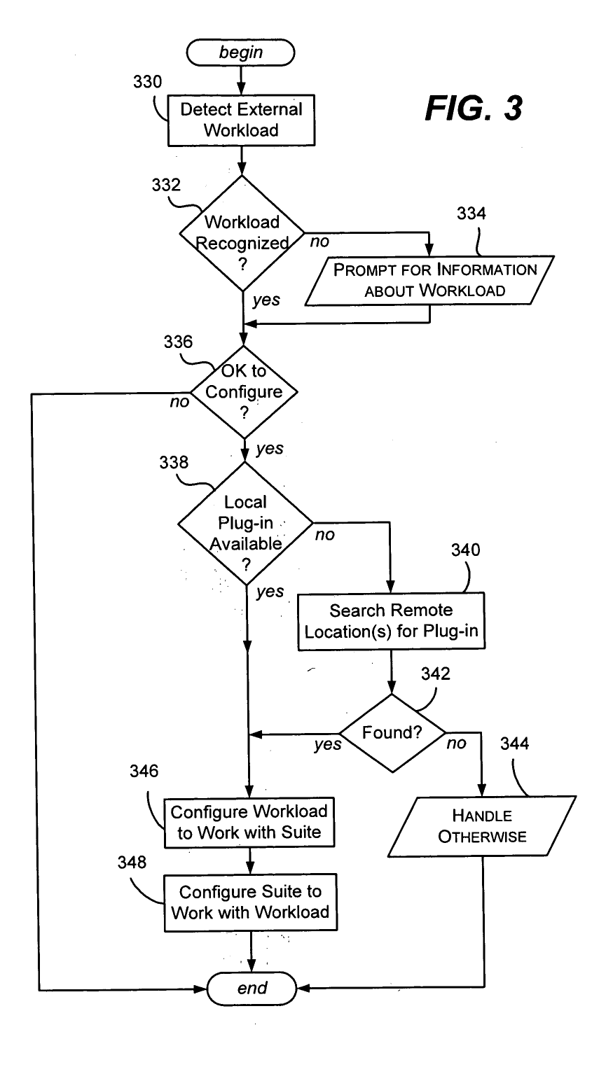

FIG. 3 is a flow diagram showing example steps that may be used to configure a detected workload for use with suite software, and configure the suite software to work with the detected workload, beginning at step 300 where an external workload is detected.

Step 332 represents evaluating whether the detected workload is recognized by the suite software. For example, certain types and/or models of devices may be commonplace in networks, while other similar devices may already exist on the network, whereby the suite may already have access to information about that particular type. If not, step 334 represents prompting the administrator to obtain information about the detected workload, e.g., its type, manufacturer, model number and so forth, essentially any data needed to locate an appropriate plug-in for that workload.

Step 336 represents confirming whether it is okay to configure this device (and the suite software) for integration into the network. This confirmation may be obtained via a prompt to an administrator, or by some other mechanism, such as looking up stored instructions as to which workloads are pre-confirmed to automatically integrate, (e.g., followed by a prompt if not pre-confirmed). The process exemplified in FIG. 3 ends if not confirmed in some way as okay for configuration, e.g., a network user may have added some personal device to a network computer that the administrator does not want to make part of the network.

If configuration is confirmed, step 336 branches to step 338 to determine whether a plug-in containing configuration information is locally available for that workload. If not, step 338 branches to step 340 to search one or more remote locations for a plug-in, such as a device manufacturer's website; a remote location may be a remote site of a given organization, and/or the Internet. Note that in an alternative implementation, remote locations can be searched for a more recent update of a plug-in even when a local plug-in is available.

If no local plug-in is available at step 338 and none are found at step 342, some other action is taken at step 344. For example, the administrator may be notified that no plug-in could be found, and if integration is still desired, that manual configuration is necessary (or a plug-in needs to be provided).

In the event a local or remote plug-in is located, step 346 represents configuring the workload to work with the suite based on information in the plug-in. Step 348 represents configuring the suite to work with the workload. At this time, the workload is integrated into the suite.

To summarize, the suite includes a mechanism that detects workloads in a network environment, and automatically or with the user's intervention (e.g., to identify what make/model of the workload is, downloads the appropriate plug-in (if not already installed) to allow the suite to control and configure the device. In addition the plug-in contains the information for the type of device and the configuration that the suite needs to configure itself to work with it, and the information needed for the suite to configure the device to work with suite.

### EXEMPLARY OPERATING ENVIRONMENT

FIG. 4 illustrates an example of a suitable computing system environment 400 on which the workload detection and configuration mechanism 220 (FIG. 2) may be implemented. The computing system environment 400 is only one example of a suitable computing environment and is not intended to suggest any limitation as to the scope of use or functionality of the invention. Neither should the computing environment 400 be interpreted as having any dependency or requirement relating to any one or combination of components illustrated in the exemplary operating environment 400.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 4, an exemplary system for implementing various aspects of the invention may include a general purpose computing device in the form of a computer 410. Components of the computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 410 typically includes a variety of computer-readable media. Computer-readable media can be any available media that can be accessed by the computer 410 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, whether internal (e.g., a hard disk drive) or external (e.g., a USB drive), or any other medium which can be used to store the desired information and which can accessed by the computer 410. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436 and program data 437.

The computer 410 may also include other removable/non-removable, volatile/nonvolatile computer storage media. By way of example only, FIG. 4 illustrates a hard disk drive 441 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media, described above and illustrated in FIG. 4, provide storage of computer-readable instructions, data structures, program modules and other data for the computer 410. In FIG. 4, for example, hard disk drive 441 is illustrated as storing operating system 444, application programs 445, other program modules 446 and program data 447. Note that these components can either be the same as or different from operating system 434, application programs 435, other program modules 436, and program data 437. Operating system 444, application programs 445, other program modules 446, and program data 447 are given different numbers herein to illustrate that, at a minimum, they are different copies. A user may enter commands and information into the computer 410 through input devices such as a tablet, or electronic digitizer, 464, a microphone 463, a keyboard 462 and pointing device 461, commonly referred to as mouse, trackball or touch pad. Other input devices not shown in FIG. 4 may include a joystick, game pad, satellite dish, scanner, or the like. These and other input devices are often connected to the processing unit 420 through a user input interface 460 that is coupled to the system bus, but may be connected by other interface and bus structures, such as a parallel port, game port or a universal serial bus (USB). A monitor 491 or other type of display device is also connected to the system bus 421 via an interface, such as a video interface 490. The monitor 491 may also be integrated with a touch-screen panel or the like. Note that the monitor and/or touch screen panel can be physically coupled to a housing in which the computing device 410 is incorporated, such as in a tablet-type personal computer. In addition, computers such as the computing device 410 may also include other peripheral output devices such as speakers 495 and printer 496, which may be connected through an output peripheral interface 494 or the like.

The computer 410 may operate in a networked environment using logical connections to one or more remote computers, such as a remote computer 480. The remote computer 480 may be a personal computer, a server, a router, a network PC, a peer device or other common network node, and typically includes many or all of the elements described above relative to the computer 410, although only a memory storage device 481 has been illustrated in FIG. 4. The logical connections depicted in FIG. 4 include one ore more local area networks (LAN) 471 and one or more wide area networks (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the Internet. The modem 472, which may be internal or external, may be connected to the system bus 421 via the user input interface 460 or other appropriate mechanism. A wireless networking component such as comprising an interface and antenna may be coupled through a suitable device such as an access point or peer computer to a WAN or LAN. In a networked environment, program modules depicted relative to the computer 410, or portions thereof, may be stored in the remote memory storage device. By way of example, and hot limitation, FIG. 4 illustrates remote application programs 485 as residing on memory device 481. It may be appreciated that the network connections shown are exemplary and other means of establishing a communications link between the computers may be used.

An auxiliary subsystem 499 (e.g., for auxiliary display of content) may be connected via the user interface 460 to allow data such as program content, system status and event notifications to be provided to the user, even if the main portions of the computer system are in a low power state. The auxiliary subsystem 499 may be connected to the modem 472 and/or network interface 470 to allow communication between these systems while the main processing unit 420 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computer network, a method, comprising:
detecting a network workload;
locating configuration information associated with the workload; and
integrating the workload into the network, by:
a) configuring the workload to operate in the network based on the configuration information; and
b) configuring a network program to work with the workload.

2. The method of claim 1 wherein locating the configuration information comprises accessing an on-premise data store to locate a plug-in.

3. The method of claim 1 wherein locating the configuration information comprises searching at least one remote location for a plug-in.

4. The method of claim 1 wherein locating the configuration information comprises accessing an on-premise data store to locate a plug-in containing data corresponding to the configuration information, and if not found in the on-premise data store, searching at least one remote location for the plug-in.

5. The method of claim 1 wherein locating the configuration information comprises accessing an on-premise data store to locate a plug-in containing data corresponding to the configuration information, or searching at least one remote location for the plug-in, or both, and further comprising, if the plug-in is not found in the on-premise data store or remote location, prompting a user to enter configuration-related data or a path to the plug-in.

6. At least one computer-readable media having computer-executable instructions, which when executed perform steps, comprising:
locating configuration information associated with a workload of a network in which the workload is detected as being associated with at least one component of a network but is not integrated into the network; and
integrating the workload into the network by processing the configuration information to configure at least one setting of the workload to operate as part of the network.

7. The computer-readable media of claim 6 having further computer executable instructions comprising, configuring a network program to work with the workload.

8. The computer-readable media of claim 7 wherein the network program comprises network suite software including a mechanism for locating the configuration information or processing the configuration information, or for locating the configuration information and processing the configuration information.

9. The computer-readable media of claim 6 wherein locating the configuration information comprises accessing an on-premise data store to locate a plug-in.

10. The computer-readable media of claim 6 wherein locating the configuration information comprises searching at least one remote location for a plug-in.

11. The computer-readable media of claim 6 wherein locating the configuration information comprises accessing an on-premise data store to locate a plug-in containing data corresponding to the configuration information, and if not found in the on-premise data store, searching at least one remote location for the plug-in.

12. The computer-readable media of claim 6 wherein locating the configuration information comprises accessing an on-premise data store to locate a plug-in containing data corresponding to the configuration information, or searching at least one remote location for the plug-in, or both, and further comprising, if the plug-in is not found in the on-premise data store or remote location, prompting a user to enter data corresponding to the configuration information or a path to the plug-in, or both.

13. In a computer environment including a network, a system comprising:
a software suite including at least one program that manages the network; and
a mechanism incorporated into or coupled to the software suite that locates configuration information associated with a network workload that is detected as being associated with the network but not integrated into the network, the mechanism integrating the workload into the network for use by the software suite by processing the configuration information to configure the workload and by modifying at least one software suite setting.

14. The system of claim 13 wherein the workload comprises a device, a service or a product.

15. The system of claim 13 wherein the workload comprises a storage device or a firewall device.

16. The system of claim 13 further comprising an on-premise data store coupled to the mechanism for access thereby, the on-premise data store maintaining at least one data structure containing data corresponding to the configuration information.

17. The system of claim 13 further comprising remote access means coupled to the mechanism, the remote access means configured for use by the mechanism in locating a remote data structure containing data corresponding to the configuration information.

18. The system of claim 13 further comprising a workload detection mechanism for detecting the workload, including by scanning the network for specific workloads using workload-specific characteristics, including network configuration, network broadcasts or network probes, or any combination of network configuration, network broadcasts or network probes.

19. The system of claim 13 further comprising a workload detection mechanism for detecting the workload, including by querying configuration data stores associated with the network.

20. The system of claim 13 further comprising a workload detection mechanism for detecting the workload, including by receiving information from a user interface or from one or more input files, or from both a user interface and from one or more input files.
